(19) United States
(12) Patent Application Publication
(10) Pub. No.: US 2015/0297438 A1
(43) Pub. Date: Oct. 22, 2015

(54) AXILLARY CRUTCH

(71) Applicant: Cheng-Hung Hsu, Taipei City (TW)

(72) Inventor: CHENG-HUNG HSU, New Taipei City (TW)

(73) Assignee: Cheng-Hung Hsu, Taipei City (TW)

(21) Appl. No.: 14/255,313

(22) Filed: Apr. 17, 2014

(51) Int. Cl. A61H 3/02

(52) U.S. Cl. CPC A61H 3/02

(57) ABSTRACT

An axillary crutch contains a first support unit including two parallel first support columns, an armpit pad, two first connecting segments, and a grip bar; a second support unit including two parallel second support columns and an abutting pad, and the two parallel second support columns coupling with the two parallel first support columns; a positioning unit including two first fixing portions, an operating member, and two second fixing portions. The two first connecting segments of the first support unit are coupled on two top ends of the two parallel second support columns, and the two first fixing portions are locked with the two second fixing portions, such that when the operating member is pulled, the two first fixing portions remove from the two second fixing portions so that the first support unit and the second support unit are retracted.

### FIELD OF THE INVENTION

The present invention relates to a crutch, and more particularly to an axillary crutch which is retracted in a small size easily.

### BACKGROUND OF THE INVENTION

A conventional axillary crutch is employed to assist injured or disabled user in walking and its length is fixed, so the conventional axillary crutch cannot be retracted in a small size and is portable inconveniently.

To overcome such a problem, a collapsible axillary crutch is developed and contains an upper support column and a lower support column between which a spring set and a slidable sleeve are defined. The spring set is biased against the slidable sleeve, and the slidable sleeve is mounted on a bottom end of the upper support column so that the upper support column and the lower support column are maintained at a vertical standing position to assist the user in walking. As desiring to retract the collapsible axillary crutch, the slidable sleeve is pulled by one hand to retract backwardly from the lower support column so that it is kept in an unfixing state, and then the lower support column is bent by the other hand to retract the collapsible axillary crutch.

However, this collapsible axillary crutch is retracted with two hands to cause troublesome operation. Moreover, the upper support column and the lower support column are positioned by means of the spring set and the slidable sleeve, hence this positioning structure (including the spring set and the slidable sleeve) are complicated, and an elasticity of the spring set will be fatigued after a period of using time.

The present invention has arisen to mitigate and/or obviate the afore-described disadvantages.

### SUMMARY OF THE INVENTION

The primary object of the present invention is to provide an axillary crutch in which an operating member is gripped and pulled downwardly by one hand so that a first support unit is bent along two first coupling portions and two second coupling portions, and then two first fixing portions remove from two second fixing portions, the first support unit moves close to the second support unit, thereby retracting the axillary crutch easily and quickly.

To obtain the above objective, an axillary crutch provided by the present invention contains: a first support unit, a second support unit, and a positioning unit.

The first support unit includes two parallel first support columns, an armpit pad disposed on two top ends of the two parallel first support columns, two first connecting segments mounted on two bottom ends of the two parallel first support columns, and a grip bar defined between two middle sections of the two parallel first support columns.

The second support unit includes two parallel second support columns and an abutting pad disposed on two bottom ends of the two parallel second support columns, and the two parallel second support columns couple with the two parallel first support columns.

The positioning unit includes two first fixing portions secured on the two first connecting segments, an operating member coupled with the two first fixing portions, and two second fixing portions arranged on the parallel second support columns.

The two first connecting segments of the first support unit are coupled on two top ends of the two parallel second support columns, and the two first fixing portions are locked with the two second fixing portions, such that when the operating member is pulled, the two first fixing portions remove from the two second fixing portions so that the first support unit and the second support unit are retracted.

### BRIEF DESCRIPTION OF THE DRAWINGS

FIG. 1 is a perspective view showing the assembly of an axillary crutch according to a preferred embodiment of the present invention.

FIG. 2 is a perspective view showing the operation of the axillary crutch according to the preferred embodiment of the present invention.

FIG. 3 is a cross sectional view showing a part of the assembly of the axillary crutch according to the preferred embodiment of the present invention.

FIG. 4 is a plane view showing a part of the operation of the axillary crutch according to the preferred embodiment of the present invention.

FIG. 5 is a perspective view showing a part of the operation of the axillary crutch according to the preferred embodiment of the present invention.

### DETAILED DESCRIPTION OF THE PREFERRED EMBODIMENTS

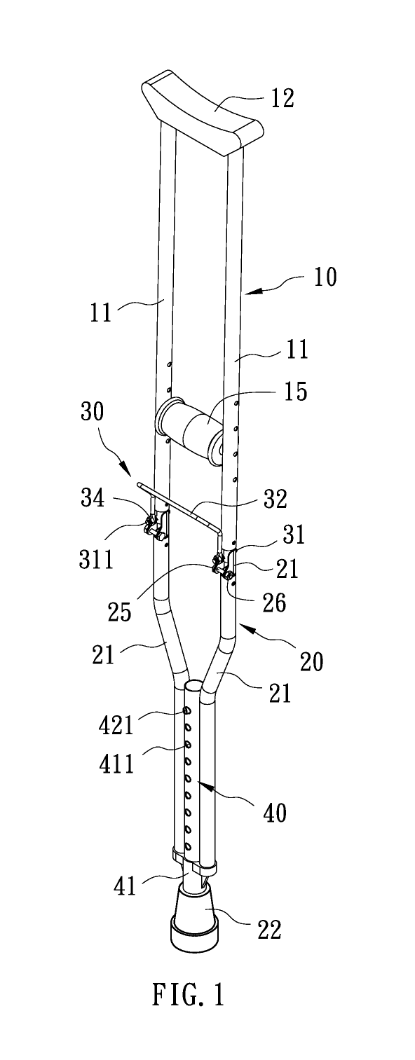

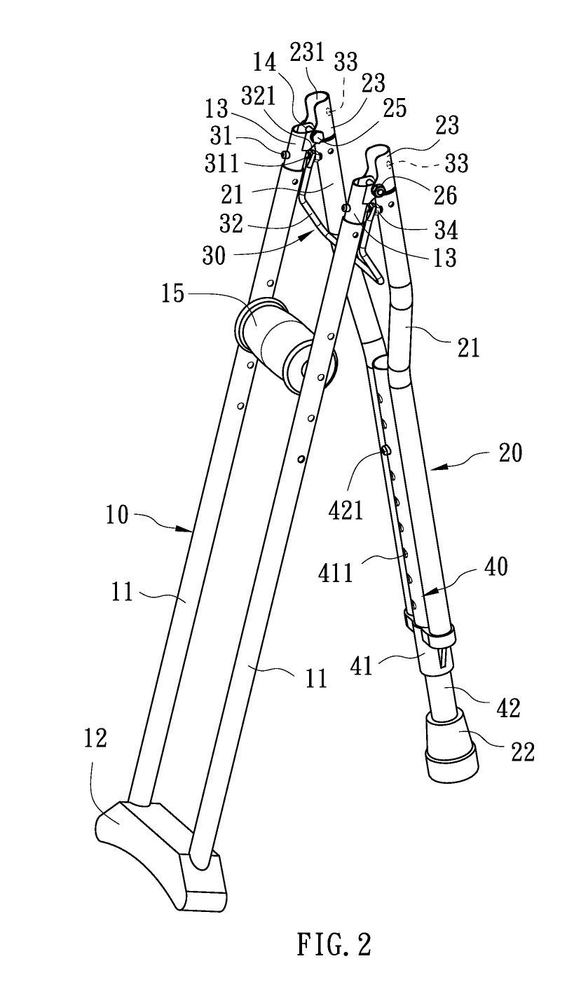

With reference to FIGS. 1 and 2, an axillary crutch according to a preferred embodiment of the present invention comprises: a first support unit 10, a second support unit 20, a positioning unit 30, and an adjusting unit 40.

The first support unit 10 includes two parallel first support columns 11, an armpit pad 12 disposed on two top ends of the two parallel first support columns 11, two first connecting segments 13 mounted on two bottom ends of the two parallel first support columns 11, two first coupling portions 14 fixed on two sides of the two first connecting segments 13, and a grip bar 15 defined between two middle sections of the two parallel first support columns 11.

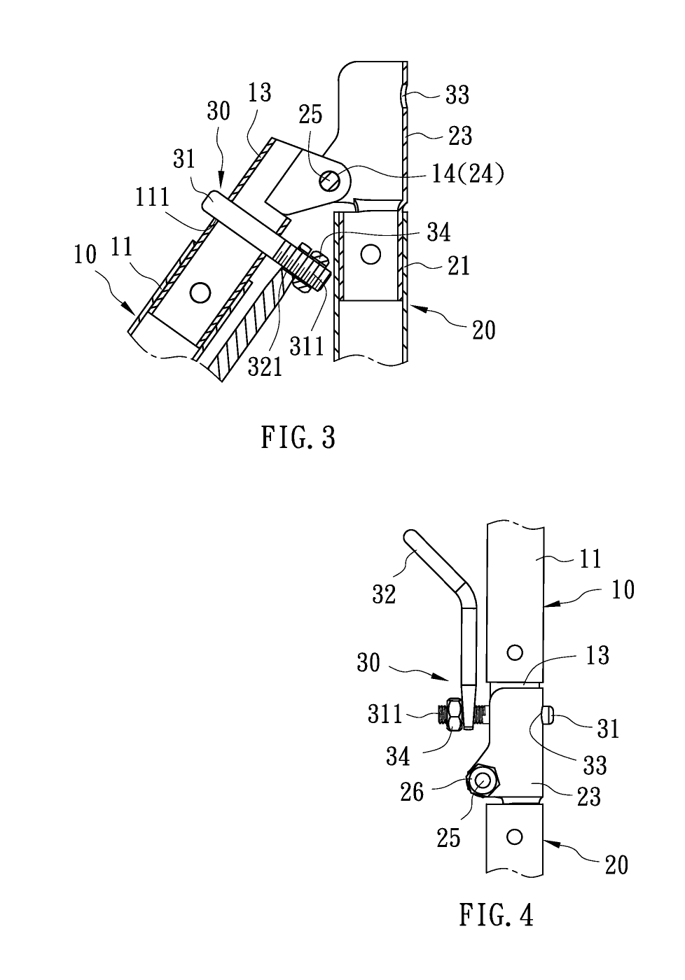

The second support unit 20 includes two parallel second support columns 21, an abutting pad 22 disposed on two bottom ends of the two parallel second support columns 21, two second connecting segments 23 mounted on two top ends of the two parallel second support columns 21, and two second coupling portions 24 for connecting with the two first coupling portions 14. Referring further to FIG. 3, two locking elements 25 are axially fixed on the two first coupling portions 14 and the two second coupling portions 24, and two first nuts 26 are screwed with the two locking elements 25 so that the first support unit 10 is in connection with the second support unit 20.

Furthermore, each second connecting segment 23 of the second support unit 20 is tubular and has an opening 231, a diameter of each first connecting segment 13 is less than that of each second connecting segment 23 so that each first connecting segment 13 is inserted into each second connecting segment 23 via the opening 231.

As shown in FIGS. 3 and 4, the positioning unit 30 includes two first fixing portions 31 secured on the two first connecting segments 13, an operating member 32 coupled with the two first fixing portions 31, and two second fixing portions 33 arranged on the two second connecting segments 23. In this embodiment, each first fixing portion 31 is a bolt element, and each second fixing portion 33 is a through hole. In addition, the two second fixing portions 33 are arranged on two positions of two front sides of the axillary crutch, and the operating member 32 is located at two positions of two rear sides of the axillary crutch opposite to the two second fixing portions 33.

When the two connecting segments 13 of the first support unit 10 are coupled with the two second connecting segments 23 of the second support unit 20, the two first fixing portions 31 are locked with the two second fixing portions 33. The two first fixing portions 31 are inserted into two orifices 111 of the two parallel first support columns 11, and each of the two first fixing portions 31 has a threaded section 311 arranged around a rear end thereof. The operating member 32 is formed in an inverted U shape and has two screwing apertures 321 defined on two ends thereof and screwing with two threaded sections 311 of the two first fixing portions 31, such that two screwing apertures 321 of the operating member 32 are screwed with the two threaded sections 311 of the two first fixing portions 31, and two second nuts 34 are locked with the two threaded sections 311 so that the operating member 32 is coupled with the two first fixing portions 31 which are secured on the two first connecting segments 13 of the two parallel first support columns 11.

The adjusting unit 40 includes an upper tube 41 and a lower tube 42 inserted into the upper tube 41, and the upper tube 41 has a plurality of pores 411 longitudinally arranged around an peripheral wall thereof, the lower tube 42 has a resilient retaining tab 421 for retaining in one of the plurality of pores 411. The abutting pad 22 of the second support unit 20 is also fixed on a bottom end of the lower tube 42. Thereby, the resilient retaining tab 421 is pressed to align and lock with one of the plurality of pores 411, thus adjusting an extending length of the axillary crutch based on user's height.

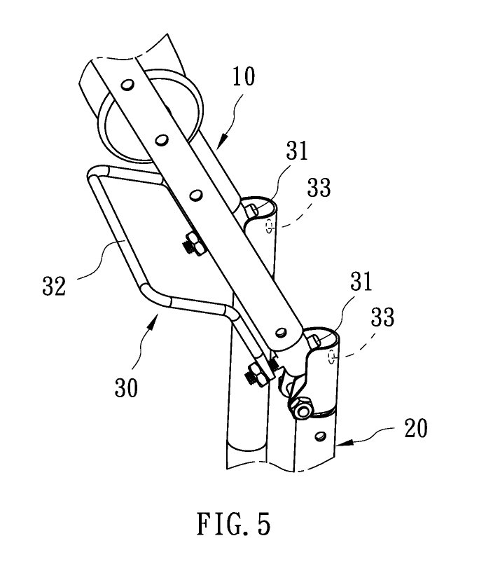

As illustrated in FIG. 5, as desiring to retract the axillary crutch, the operating member 32 is gripped and pulled downwardly by one hand so that the first support unit 10 is bent along the two first coupling portions 14 and the two second coupling portions 24 (as shown in FIG. 3), and then the two first fixing portions 31 remove from the two second fixing portions 33, the first support unit 10 moves close to the second support unit 20, thereby retracting the axillary crutch easily and quickly (as illustrated in FIG. 2).

After the two parallel first support columns 11 are pulled outwardly relative to the two second support columns 21, the two first fixing portions 31 are locked with the two second fixing portions 33 (as shown in FIG. 3) so that the first support unit 10 and the second support unit 20 are connected together as illustrated in FIG. 1, hence injured or disabled user can walk by using the axillary crutch.

The axillary crutch of the present invention has advantages as follows:

1. The axillary crutch is operated by one hand to retract the first support unit 10 and the second support unit 20 easily, thus storing and carrying the axillary crutch conveniently.

2. The two first fixing portions 31 are locked with the two second fixing portions 33 so that the first support unit 10 and the second support unit 20 are connected together securely.

3. The first support unit 10 and the second support unit 20 are fixed securely by periodically checking whether the two second nuts 34 are locked with the two threaded sections 311 tightly.

4. The axillary crutch is retraced in a small size to be portable easily and to save packaging and transportation costs.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An axillary crutch comprising:
a first support unit including two parallel first support columns, an armpit pad disposed on two top ends of the two parallel first support columns, two first connecting segments mounted on two bottom ends of the two parallel first support columns, and a grip bar defined between two middle sections of the two parallel first support columns;
a second support unit including two parallel second support columns and an abutting pad disposed on two bottom ends of the two parallel second support columns, and the two parallel second support columns coupling with the two parallel first support columns;
a positioning unit including two first fixing portions secured on the two first connecting segments, an operating member coupled with the two first fixing portions, and two second fixing portions arranged on the parallel second support columns;
wherein the two first connecting segments of the first support unit are coupled on two top ends of the two parallel second support columns, and the two first fixing portions are locked with the two second fixing portions, such that when the operating member is pulled, the two first fixing portions remove from the two second fixing portions so that the first support unit and the second support unit are retracted.

2. The axillary crutch as claimed in claim 1, wherein each first fixing portion is a screw bolt, and each second fixing portion is a through hole.

3. The axillary crutch as claimed in claim 1, wherein the two second fixing portions are arranged on two positions of two front sides of an axillary crutch, and the operating member is located at two positions of two rear sides of the axillary crutch opposite to the two second fixing portions.

4. The axillary crutch as claimed in claim 1, wherein the first support unit further includes two first coupling portions fixed on two sides of the two first connecting segments, and the second support unit further includes two second connecting segments mounted on the two top ends of the two parallel second support columns and two second coupling portions fixed on the two second connecting segments, wherein the two first coupling portions correspond to the two second coupling portions, and the two parallel first support columns are connected with the two parallel second support columns by ways of plural locking elements and plural first nuts.

5. The axillary crutch as claimed in claim 1, wherein each second connecting segment of the second support unit is tubular and has an opening, a diameter of each first connecting segment is less than that of each second connecting segment so that each first connecting segment is inserted into each second connecting segment via the opening.

6. The axillary crutch as claimed in claim 1 further comprising an adjusting unit including an upper tube and a lower tube inserted into the upper tube, and the upper tube having a plurality of pores longitudinally arranged around an peripheral wall thereof, the lower tube having a resilient retaining tab for retaining in one of the plurality of pores, wherein the abutting pad of the second support unit is also fixed on a bottom end of the lower tube.

7. The axillary crutch as claimed in claim 1, wherein the two first fixing portions of the positioning unit are inserted into two orifices of the two parallel first support columns, and each of the two first fixing portions has a threaded section arranged around a rear end thereof, the operating member is formed in an inverted U shape and has two screwing apertures defined on two ends thereof and screwing with two threaded sections of the two first fixing portions, such that two screwing apertures of the operating member are screwed with the two threaded sections of the two first fixing portions, and two second nuts are locked with the two threaded sections.
